(19) United States
(12) Patent Application Publication
(10) Pub. No.: US 2026/0163475 A1
(43) Pub. Date: Jun. 11, 2026

(54) CONTROLLER CAPABLE OF DETECTING A DIRECT CURRENT (DC) VOLTAGE INFORMATION

(71) Applicant: Leadtrend Technology Corp., Hsinchu County (TW)

(72) Inventor: Jian-Zhou Yan, Hsinchu County (TW)

(73) Assignee: Leadtrend Technology Corp., Hsinchu County (TW)

(21) Appl. No.: 19/193,934

(22) Filed: Apr. 29, 2025

(30) Foreign Application Priority Data
Dec. 11, 2024 (TW) 113148099

(51) Int. Cl. H02M 1/42; H02M 1/44

(52) U.S. Cl. CPC H02M 1/4208; H02M 1/44

(57) ABSTRACT

A controller capable of detecting a direct current (DC) voltage information is applied to a power factor correction (PFC) power converter. The controller includes an active switch and a filter. The active switch is used for receiving a detection signal from a detection pin of the controller, and filtering a voltage component of the detection signal to generate a first signal, wherein the voltage component relates to a turning-on period of a power switch of the PFC power converter. The filter is coupled to the active switch and used for filtering a switching component of the first signal to generate the DC voltage information.

### BACKGROUND OF THE INVENTION

### 1. Field of the Invention

The present invention relates to a controller applied to a power factor correction (PFC) power converter, and particularly to a controller that can detect direct current (DC) voltage information of a PFC power converter.

### 2. Description of the Prior Art

In the prior art, a PFC power converter divides a DC voltage VIN (high voltage) into the DC voltage VIN (low voltage) and inputs the DC voltage VIN (low voltage) to a controller applied to the PFC power converter through an input voltage pin of the controller, wherein the DC voltage VIN (high voltage) is generated by a bridge rectifier rectifying an alternating voltage inputted to the PFC power converter. However, due to severe environmental spike interference outside the controller, an external grounded capacitor is required to filter the noise on the DC voltage VIN (low voltage). That is to say, not only the controller receiving the DC voltage VIN (low voltage) through the input voltage pin requires cost for installing the input voltage pin, but also environmental spikes outside the controller are coupled to the DC voltage VIN (low voltage).

Therefore, how to improve the above mentioned drawbacks of the prior are has become an important issue for a designer of the controller.

### SUMMARY OF THE INVENTION

An embodiment of the present invention provides a controller capable of detecting a direct current (DC) voltage information, wherein the controller is applied to a power factor correction (PFC) power converter. The controller includes an active switch and a filter. The active switch receives a detection signal from a detection pin of the controller, and filters a voltage component of the detection signal to generate a first signal, wherein the voltage component relates to a turning-on period of a power switch of the power factor correction power converter. The filter is coupled to the active switch, wherein the filter is used for filtering a switching component of the first signal to generate the DC voltage information.

According to one aspect of the present invention, the filter is a low-pass filter.

According to one aspect of the present invention, the first signal is in positive proportion to a drain voltage of the power switch of the power factor correction power converter.

According to one aspect of the present invention, the DC voltage information is in positive proportion to a DC voltage of the power factor correction power converter.

According to one aspect of the present invention, the switching component relates to a driving signal for controlling the power switch of the power factor correction power converter, and the driving signal is a pulse width modulation signal.

According to one aspect of the present invention, during a turning-off period of the power switch of the power factor correction power converter, the controller is further used for executing over-voltage protection or zero-crossing detection according to the detection signal.

According to one aspect of the present invention, the controller according to the DC voltage information further executes brown in/brown out protection, or high line/low line detection), or total harmonic distortion (THD) optimization.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a controller applied to a power factor correction (PFC) power converter according to a first embodiment of the present invention.

FIG. 2 is a diagram illustrating the detection signal, the first signal, and the drain voltage.

FIG. 3 is a diagram illustrating relationships between the DC voltage information and the DC voltage under different phases (e.g. 0 degree, 45 degrees, 90 degrees) of the alternating voltage.

### DETAILED DESCRIPTION

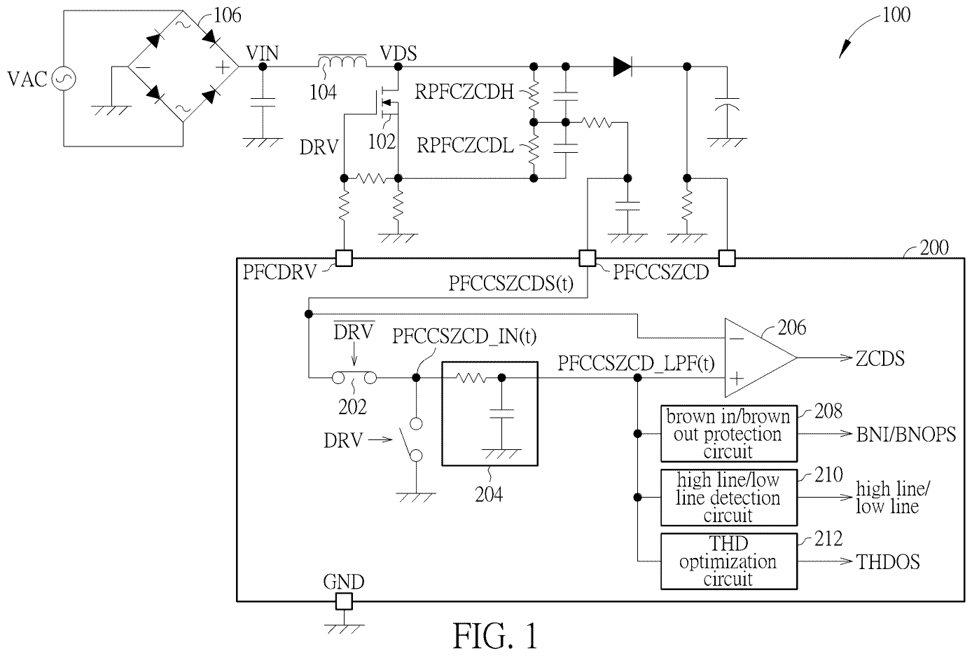

Please refer to FIG. 1. FIG. 1 is a diagram illustrating a controller 200 applied to a power factor correction (PFC) power converter 100 according to a first embodiment of the present invention, wherein the controller 200 at least includes an active switch 202 and a filter 204, wherein the filter 204 is coupled to the active switch 202, the filter 204 is an nth order low-pass filter, and n is a positive integer. In addition, the PFC power converter 100 is a PFC boost converter. As shown in FIG. 1, the active switch 202 is used for receiving a detection signal PFCCSZCDS(t) from a pin PFCCSZCD of the controller 200, and filtering a voltage component VCS(t) of the detection signal PFCCSZCDS(t) to generate a first signal PFCCSZCD_IN(t), wherein the detection signal PFCCSZCDS(t) and the first signal PFCCSZCD_IN(t) can be referred to equation (1) and equation (2) respectively, and the voltage component VCS(t) relates to a turning-on period TON of a power switch 102 of the PFC power converter 100:

$$PFCCSZCDS ( t ) = VCS ( t ) + VDS ( t ) \times \frac{R P F C Z C D L}{R P F C Z C D H + R P F C Z C D L} \qquad ( 1 )$$

$$PFCCSZCD\_IN ( t ) = VDS ( t ) \times \frac{R P F C Z C D L}{R P F C Z C D H + R P F C Z C D L} \qquad ( 2 )$$

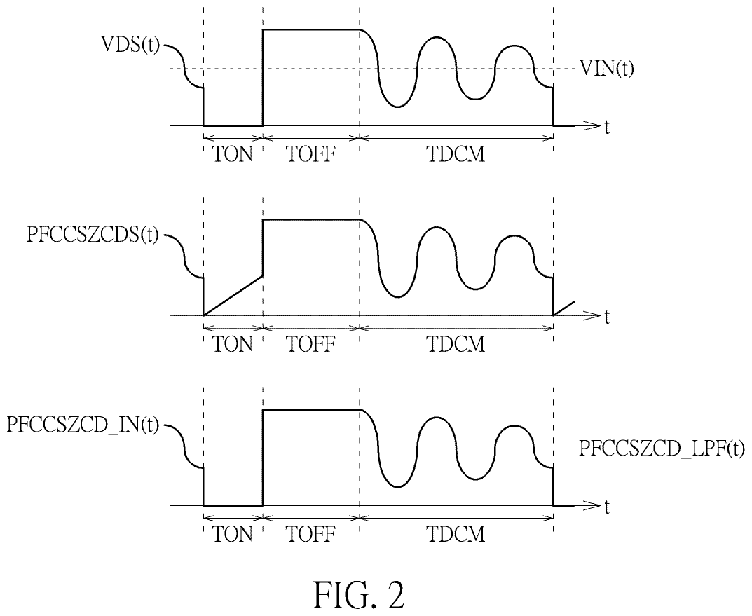

As shown in equation (1) and equation (2), all of the detection signal PFCCSZCDS(t), the voltage component VCS(t), the first signal PFCCSZCD_IN(t), and a drain voltage VDS(t) of the power switch 102 are functions of time t, RPFCZCDH is an upper resister of the PFC power converter 100, RPFCZCDL is a lower resister of the PFC power converter 100, and a resistance of the upper resister RPFCZCDH and a resistance of the lower resister RPFCZCDL are fixed values. In addition, the detection signal PFCCSZCDS(t), the first signal PFCCSZCD_IN(t), and the drain voltage VDS(t) can be referred to FIG. 2, wherein TON represents the turning-on period of the power switch 102, TOFF represents a turning-off period of the power switch 102, and TDCM represents a resonance period of an inductor 104 of the PFC power converter 100.

In addition, according to the voltage-second balance, it is very clear that an integral of the drain voltage VDS(t) with respect to time t is zero. That is to say, an average of the drain voltage VDS(t) is equal to a DC voltage VIN(t), wherein the DC voltage VIN(t) is generated by a bridge rectifier 106 rectifying an alternating voltage VAC inputted to the PFC power converter 100. In addition, according to equation (2), it is very clear that the first signal PFCCSZCD_IN(t) is in positive proportion to the drain voltage VDS(t). Therefore, because the filter 204 is an nth order low-pass filter, the filter 204 can average the first signal PFCCSZCD_IN(t) to filter out a switching component of the first signal PFCCSZCD_IN(t) to generate a DC voltage information PFCCSZCD_LPF(t), wherein the DC voltage information PFCCSZCD_LPF(t) can be referred to equation (3):

$$PFCCSZCD\_LPF ( t ) = \times \frac{R P F C Z C D L}{R P F C Z C D H + R P F C Z C D L} \qquad ( 3 )$$

As shown in equation (3), it is very clear that because both the resistance of the upper resister RPFCZCDH and the resistance of the lower resister RPFCZCDL are fixed values, the DC voltage information PFCCSZCD_LPF(t) is in positive proportion to the DC voltage VIN(t). In addition, the switching component relates to a driving signal DRV of the power switch 102, the driving signal DRV is a pulse width modulation signal, and the controller 200 transmits the driving signal DRV to the power switch 102 through a pin PFCDRV. In addition, the controller 200 is grounded through a pin GND.

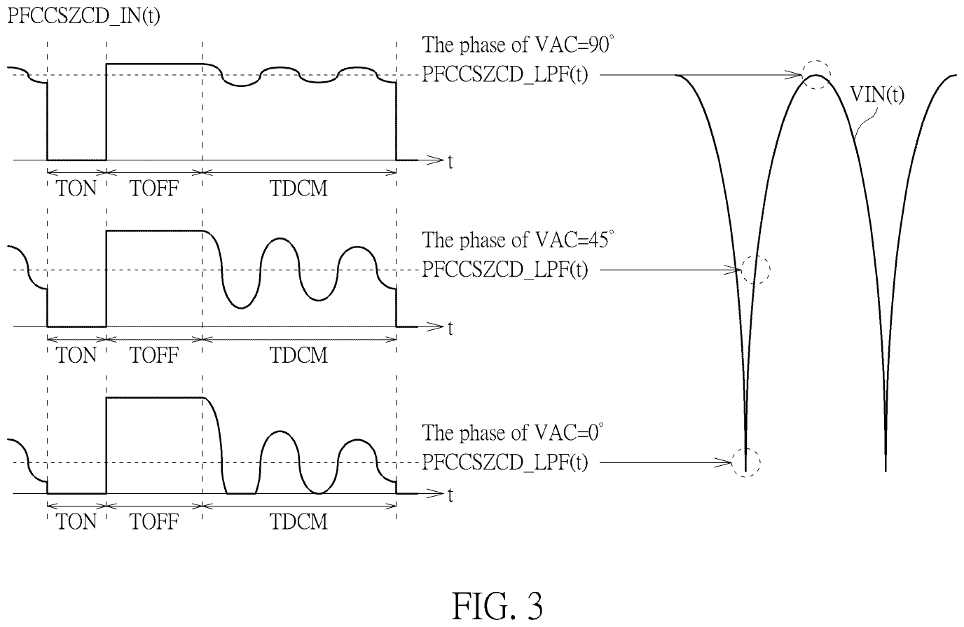

In addition, because the DC voltage information PFCCSZCD_LPF(t) is in positive proportion to the DC voltage VIN(t), and the DC voltage VIN(t) is generated by the bridge rectifier 106 rectifying the alternating voltage VAC, under different phases (e.g. 0 degree, 45 degrees, 90 degrees) of the alternating voltage VAC, relationships between the DC voltage information PFCCSZCD_LPF(t) and the DC voltage VIN(t) can be referred to FIG. 3.

In addition, please refer to FIG. 1 and equation (1) simultaneously. Because the detection signal PFCCSZCDS(t) received from the pin PFCCSZCD includes the drain voltage VDS(t), the controller 200 can generate a zero-crossing detection signal ZCDS through a comparator 206, the detection signal PFCCSZCDS(t), and the DC voltage information PFCCSZCD_LPF(t). Afterward, a driving signal generation circuit (not shown in FIG. 1) within the controller 200 can generate the driving signal DRV to the power switch 102 according to the zero-crossing detection signal ZCDS.

In addition, please refer to FIG. 1. Because the DC voltage information PFCCSZCD_LPF(t) is in positive proportion to the DC voltage VIN(t), the controller 200 can generate a brown in/brown out protection signal BNI/BNOPS through a brown in/brown out protection circuit 208 and the DC voltage information PFCCSZCD_LPF(t). Afterward, a corresponding circuit (not shown in FIG. 1) within the controller 200 can execute brown in/brown out protection on the controller 200 according to the brown in/brown out protection signal BNI/BNOPS.

In addition, please refer to FIG. 1. Because the DC voltage information PFCCSZCD_LPF(t) is in positive proportion to the DC voltage VIN(t), the controller 200 can detect that the DC voltage VIN(t) is high line or low line through a high line/low line detection circuit 210 and the DC voltage information PFCCSZCD_LPF(t).

In addition, please refer to FIG. 1. Because the DC voltage information PFCCSZCD_LPF(t) is in positive proportion to the DC voltage VIN(t), the controller 200 can generate total harmonic distortion (THD) optimization signal THDOS through a THD optimization circuit 212 and the DC voltage information PFCCSZCD_LPF(t). Afterward, a corresponding circuit (not shown in FIG. 1) within the controller 200 can execute THD optimization on the controller 200 according to the THD optimization signal THDOS.

In addition, during a turning-off period TOFF of the power switch 102, the controller 200 can also execute over-voltage protection according to the detection signal PFCCSZCDS(t).

To sum up, because the detection signal received from the detection pin includes the drain voltage, the voltage component relating to the turning-on period of the power switch, and the DC voltage information, the controller can utilize the active switch and the filter to filter the drain voltage and the voltage component relating to the turning-on period of the power switch to leave the DC voltage information which is in positive proportion to the DC voltage, respectively. Therefore, compared to the prior art, the present invention has advantages as follows:

1) Because the present invention generate the DC voltage information which is in positive proportion to the DC voltage from the detection signal, the present invention can neglect an input voltage pin which receives the DC voltage and external components coupled to the input voltage pin in the prior art to reduce cost of the controller.

2) Although the detection signal can be utilized directly for slope detection to determine zero crossing detection, the detection signal is very easily disturbed by environmental spikes outside the controller, so the present invention utilizes the DC voltage information not including the environmental spikes outside the controller to determine zero-crossing detection to increase anti-interference capability of zero-crossing detection of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller capable of detecting a direct current (DC) voltage information, wherein the controller is applied to a power factor correction (PFC) power converter, the controller comprising:
an active switch for receiving a detection signal from a detection pin of the controller, and filtering a voltage component of the detection signal to generate a first signal, wherein the voltage component relates to a turning-on period of a power switch of the power factor correction power converter; and
a filter coupled to the active switch, wherein the filter is used for filtering a switching component of the first signal to generate the DC voltage information.

2. The controller of claim 1, wherein the filter is a low-pass filter.

3. The controller of claim 1, wherein the first signal is in positive proportion to a drain voltage of the power switch of the power factor correction power converter.

4. The controller of claim 1, wherein the DC voltage information is in positive proportion to a DC voltage of the power factor correction power converter.

5. The controller of claim 1, wherein the switching component relates to a driving signal for controlling the power switch of the power factor correction power converter, and the driving signal is a pulse width modulation signal.

6. The controller of claim 1, wherein during a turning-off period of the power switch of the power factor correction power converter, the controller is further used for executing over-voltage protection or zero-crossing detection according to the detection signal.

7. The controller of claim 1, wherein the controller according to the DC voltage information further executes brown in/brown out protection, or high line/low line detection), or total harmonic distortion (THD) optimization.
